(19) United States
(12) Patent Application Publication
(10) Pub. No.: US 2013/0339763 A1
(43) Pub. Date: Dec. 19, 2013

(54) CONTRTOL APPARATUS OF AN ELECTRONIC SYSTEM AND THE METHOD THEREIN

(71) Applicant: HUNG-YI LIN, New Taipei City (TW)

(72) Inventor: HUNG-YI LIN, New Taipei City (TW)

(73) Assignee: IDEACOM TECHNOLOGY INC., New Taipei City (TW)

(21) Appl. No.: 13/527,091

(22) Filed: Jun. 19, 2012

(51) Int. Cl. G06F 1/26

(52) U.S. Cl. 713/300

(57) ABSTRACT

The invention relates to a control apparatus of an electronic system comprising a setting module, an input module, a judging module, a comparing module, a control module and a power module. The setting module is used for setting a first predetermined condition and a second predetermined condition. When at least one input information executed via the input module by the user matches the second predetermined condition, the power module provides a second power mode corresponding to the second predetermined condition, if not, the power module provides a first power mode corresponding to the first predetermined module.

### BACKGROUND OF THE INVENTION

1. Field of the Invention

The invention is related to a control apparatus, and more specifically related to a control apparatus of an electronic system for controlling the electronic system according to various kinds of predetermined conditions set by the user.

2. Description of the Prior Art

According to the development of technology, various kinds of electronic equipments are designed for the people. Taking the mobile phone for example, it has been a popular electronic product cannot be ignored in the daily life.

As the development of technology, how to provide users simpler operation mobile phone has become an important topic for industry and business. For example, the mobile phone has automatic locking function to prevent error input due to the user error touching the keypads or touch panel of the mobile phone. But is has problem that the user needs unlock the mobile phone at first in usage. Besides, the mobile phone has a working mode and a power saving mode, when the user uses the mobile phone, it works on the working mode, otherwise, it switches to the power saving mode in order to enhance the using time period of the mobile phone. In general, in order to reach the power saving purpose, the operating system of the mobile phone provides functions for setting a predetermined time period (for example 30 second) that if the mobile phone does not detect the operation executed by the user during the predetermined time period, it switches to the power saving mode and further closes the LCD monitor or executes some relative operation to save the power for abstracting the power efficient of the mobile phone. However, the power saving manner described above has some problem that when the user watches the article or video and does not execute the button or the touch panel of the mobile phone over the predetermined time period, the mobile phone was judged to the sleep mode for controlling the operating system closing the LCD monitor of the mobile phone and switches to the power saving mode. The user must operate the button, the touch panel or even input the unlock password to recover the mobile phone into the normal working mode, but it makes the user feel inconvenient in usage.

According to the description above, the switching between the power saving mode and the normal working mode utilities a predetermined time period set by the software in first. If the mobile phone was not been operated over than the predetermined time period, the system switches to the power saving mode automatically. If the mobile phone idling for a long time period without switching to the power saving mode, it causes the power wasting; and if it switches to the power saving mode in a short time period, is confused the user for using the mobile phone.

Therefore, how to provide a control apparatus of the electronic system under the powering saving mention to reach the convenient and actual implement is an important matter for equipment factory in developing the electronic technology.

### SUMMARY OF THE INVENTION

It is therefore a primary objective of the present invention to provide a control apparatus of an electronic system suited in controlling the electronic system according to various kinds of predetermined condition set by the user in prior.

One embodiment of the present invention provides a control apparatus of an electronic system comprises a setting module, an input module, a judging module, a comparing module, a control module and a power module. The setting module is used for setting a first predetermined condition and a second predetermined condition. The input module is used for generating at least one input information. The judging module coupled to the setting module and the input module is used for judging the electronic system matches the first predetermined condition and generates a judging signal according to the judging result. The comparing module coupled to the setting module and the input module is used for comparing the at least one input information with the second predetermined condition and generates a comparing signal according to the comparing result. The control module coupled to the judging module and the comparing module is used for generating a first control signal and a second control signal according to the judging signal and the comparing signal respectively. The power module coupled to the control module is used for providing a first power mode or a second power mode according to the first control signal or the second control signal. Wherein, when the at least one input information matches the second predetermined condition, the power module provides the second power mode correspondingly, if not, the power module provides the first power mode corresponding to the first predetermined condition.

Another embodiment of the present invention provides an control method of an electronic system including following steps: (a) setting a first predetermined condition and a second predetermined condition; (b) judging whether the electronic system matches the first predetermined condition and generating a judging signal according to the judging result; (c) generating at least one input information via an input module; (d) comparing the at least one input information with the second predetermined condition and generating a comparing signal according to the comparing result; (e) generating a first control signal or a second control signal according to the judging signal and the comparing signal respectively; and (f) providing a first power mode or a second power mode to the electronic system according to the first control signal or the second control signal; wherein when the at least one input information matches the second predetermined condition, the step (f) provides the second power mode to the electronic system correspondingly, if not, the step (f) provides the first power mode to the electronic system corresponding to the first predetermined condition.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an embodiment of a control apparatus of an electronic system according to the present invention.

FIG. 2 is a flow diagram of an embodiment of a control method of an electronic system according to the present invention.

FIG. 3 is a flow diagram of an embodiment of the step S54 of the control apparatus of an electronic system according to the present invention.

FIG. 4 is a flow diagram of an embodiment of the step S58 of the control apparatus of an electronic system according to the present invention.

### DETAILED DESCRIPTION

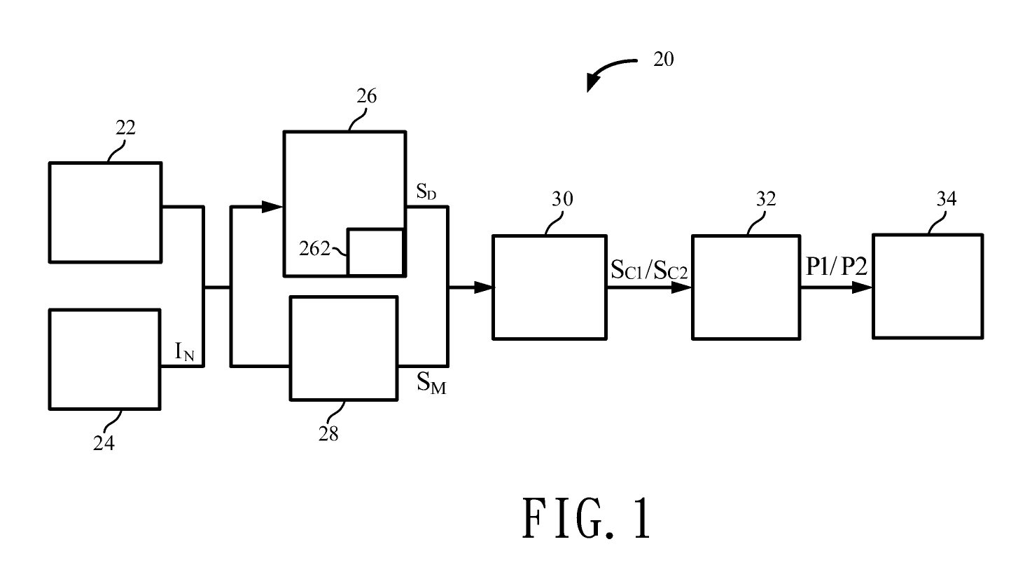

Please refer to FIG. 1. FIG. 1 is a schematic diagram of an embodiment of a control apparatus of an electronic system according to the present invention. As shown in FIG. 1, the present invention provides a control apparatus 20 of an electronic system comprises a setting module 22, an input module 24, a judging module 26, a comparing module 28, a control module 30 and a power module 32. The setting module 22 is used for setting a first predetermined condition and a second predetermined condition. The input module 24 is used for generating at least one input information I_{N} The judging module 26 coupled to the setting module 22 and the input module 24 is used for judging whether the electronic system matches first predetermined condition and then generates a judging signal S_{D} according to the judging result. The comparing module 28 coupled to the setting module 22 and the input module 24 is used for comparing the at least one input information I_{N} and the second predetermined condition and then generates a comparing signal S_{M} according to the comparing result. The control module 30 coupled to the judging module 26 and the comparing module 28 is used for generating a first control signal S_{C1} or a second control signal S_{C2} according to the judging signal S_{D} and the comparing signal S_{M} respectively. The power module 32 coupled to the control module 30 is used for providing a first power mode P1 or a second power mode P2 to the electronic system (not shown) corresponding to the first control signal S_{C1} or the second control signal S_{C2} respectively. Wherein the first power mode P1 is corresponding to the first predetermined condition and the second power mode is corresponding to the second predetermined condition, when the at least one input information IN matches to the second predetermined condition, the power module 32 provides the second power mode P2 to the electronic system (not shown) corresponding to the second predetermined condition, if not, the power module 32 provides the first power mode P1 to the electronic system (not shown) corresponding to the first predetermined condition.

In one embodiment, the control apparatus 20 further comprises a display module 34 coupled to the power module 32 which is used for displaying frames of the electronic system (not shown). The second power mode P2 provides the display module 34 power for displaying frames and the first power mode P1 provides power for disabling the displaying module 34.

The judging module 26 further comprises a counting unit 262, in one embodiment, the first predetermined condition is that if the input module 24 does not generate the input information IN, the counting unit 262 starts counting whether reach to a predetermined time period, if yes; the judging module 26 generates the judging signal SD. At the same time, the control module 30 generates the first control signal SC1 according to the judging signal SD. Wherein the predetermined time period is set by the user for the real situation of various kinds' embodiments respectively. Furthermore, when the judging module 26 receives the at least one input information IN, the judging module 26 resets the counting unit 262 to restart counting the predetermined time period. The control module 30 receives one of the judging signal SD and the comparing signal SM via the setting condition for generating the judging signal SD by the judging module 26 and generating the comparing signal SM by the comparing module 28, and executes following process according to the received signal correspondingly.

In one embodiment, the second predetermined condition is an operation gesture. The operation gesture is set by the user for actual embodiment, for example: a circle gesture or a tick gesture. The setting module 22 sets the first predetermined condition and the second predetermined condition prior according to the operation executed by a user via the input module 24. The electronic system is a computer, a tablet PC, a notebook or a smart phone and the input module 24 is a touch panel.

Taking the electronic system is a smart phone for example, the input module is a touch panel of the smart phone and the display module is the LCD monitor of the smart phone, the first predetermined condition is that switching the smart phone into power save mode and closes the LCD monitor if the touch panel does not been operated by the user more than 30 seconds. The user can operate the touch panel of smart phone via the predetermined setting by implement software of the smart phone that if the touch panel of the smart phone does not operated by the user more than 30 seconds, the smart phone closes the LCD monitor and switches to the power save mode to reach power saving effect. The power save mode is designed in general smart phones but when the user extends to watch article or connect to website, it is possible that the user does not executed operations on the touch panel of the smart phone more than 30 seconds. Accordingly, when the user watches the article, the smart phone may close the LCD monitor and switches to the power save mode because it matches the first predetermined condition (no operation on the touch panel more than 30 seconds). It confuses the user for using the smart phone.

In order to solve the problem described above, the control apparatus 20 of the electronic system of this invention provides the second predetermined condition first than the first predetermined condition. In one embodiment, the second predetermined condition is that when the user executed the predetermined gesture on the touch panel of the smart phone, the power module 32 continue supply power to the LCD monitor and does not switch the power save mode for closing the LCD monitor. Accordingly, when the user expects the smart phone more than 30 seconds and do not hope the smart phone been switched to the power save mode. The user can execute the gesture matches the second predetermined gesture to prevent the smart phone switches into the power save mode. Taking for example, the user can execute a circle gesture on the touch panel of the smart phone, at this time, even the user does not execute the smart phone over than 30 seconds, and the smart phone still does not switch into power save mode. If the user reads out the article extend to recover the original power save mode setting, the user has executed the circle gesture matches to the second predetermined condition, at this moment, the smart phone re-start the power save mode setting corresponding to the first predetermined condition again. Therefore, the smart phone with the control apparatus of this invention enhance the convenient and the implement base on the power save function.

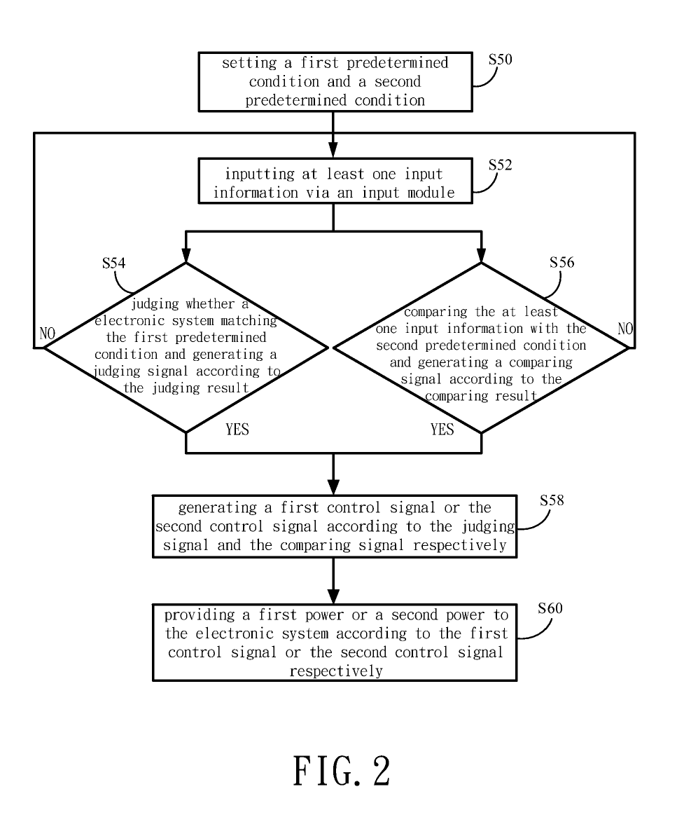

Please refer to FIG. 2. FIG. 2 is a flow diagram of an embodiment of a control method of an electronic system according to the present invention. As shown in FIG. 2, the control method of an electronic system according to the invention comprises following steps:

S50: setting a first predetermined condition and a second predetermined co0ndition;

S52: inputting at least one input information via an input module;

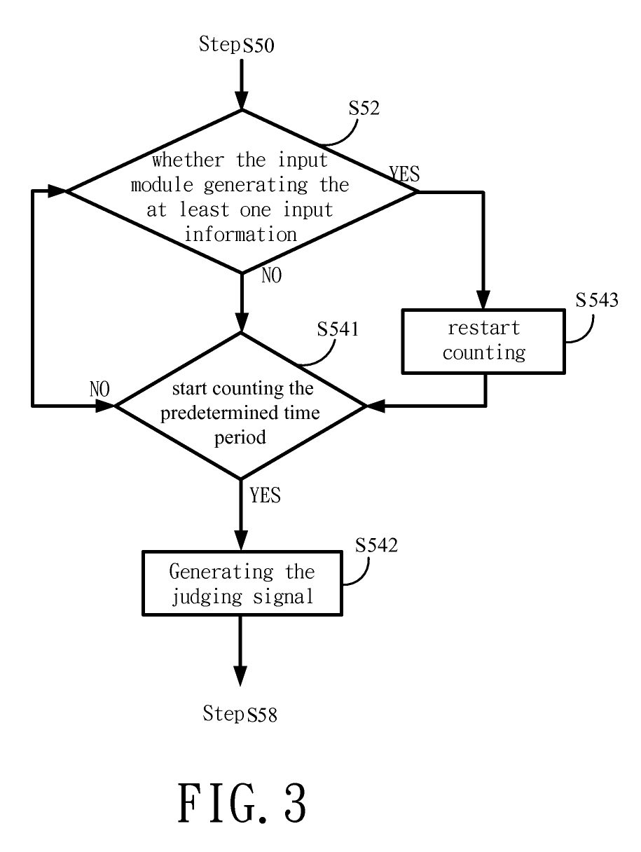

S54: judging whether an electronic system matching the first predetermined condition, if yes, go to step S58, if not, continued judging whether the electronic system match the first predetermined condition until the step S52 transmits the new input information, this step is reset and restarts the judging operation. Please refer to FIG. 3; FIG. 3 is a flow diagram of an embodiment of the step S54 of the control apparatus of an electronic system according to the present invention. As shown in the embodiment of FIG. 3, this step comprises following steps: S541: when the step S52 does not generate the at least one input information, start counting the predetermined time period; if not go to the step S542: generating the judging signal; if yes, go to the step S543: restarting counting the predetermined time period and return to the step S541 executes judging operation.

S56: comparing the at least one input information with the second predetermined condition and generating a comparing signal according to the comparing result. If the at least one input information matches the second predetermined position, go to step S58, if not, return to the step S52.

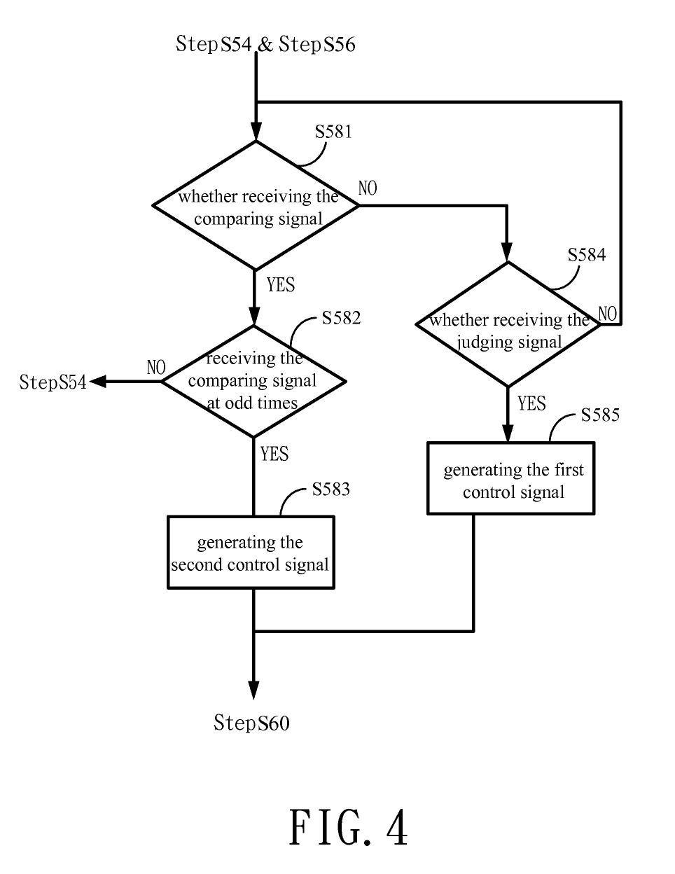

S58: generating a first control signal or a second control signal corresponding to the judging signal and the comparing signal. Please refer to FIG. 4. FIG. 4 is a flow diagram of an embodiment of the step S58 of the control apparatus of an electronic system according to the present invention. As shown in the embodiment of FIG. 4, this step includes following step S581: judging whether receiving the comparing signal, if yes, go to step S582; S582: judging whether receiving the comparing signal at odd times, if yes, going to step S583: generating the second control signal; if not, return to the step S54. If the step S581 does not receive the comparing signal, going to step S584: judging whether receiving the judging signal or not, if yes, going to step S585: generating the first control signal; if not, return to the step S581 and executes the judging operation recovery.

S60: providing a first power mode or a second power mode to the electronic system according to the first control signal and the second control signal respectively; wherein if the at least one input information matches to the second predetermined condition, the step S60 provides the second power mode to the electronic system corresponding to the second predetermined condition; if not, the step S60 provides the first power mode to the electronic system corresponding to the first predetermined condition.

The control method of an electronic system according to present invention further includes display frames via a display module. Wherein the second power mode provides power for display module to display frames and the first power mode provides power for disabling the display module.

In one embodiment, the first predetermined condition and the second predetermined condition are set via the operation executed by the user via the input module. The first predetermined condition is that if the step S52 does not generate the at least one input information, the step S54 starts counting reach a predetermined time period or not, if yes, the step generates the judging signal and the step S58 further generates the first control signal according to the judging signal. The second predetermined condition is an operation gesture. The user can executes the operation gesture matches the second predetermined condition via the input module and further generates the second control signal according to the comparing signal to apply the second power to the electronic system. Furthermore, the control method of an electronic system of this invention includes a control mechanism, when the user executes the operation gesture matches the second predetermined condition at first time or odd times and generates the comparing signal correspondingly, the electronic system consider the user executes setting operation for power mode. At this moment, the electronic system switches from the first power mode to the second power mode and provides the second power correspondingly. Otherwise, if the user executes the operation gesture matches the second predetermined condition at second times or even times and generates the comparing signal correspondingly, the electronic system considers the user remove the power setting of the electronic system, it does not generate the second power mode correspondingly and further switches from the second power mode to the first power mode corresponding to the first predetermined condition. When the electronic system matches the first predetermined condition, it provides the first power mode correspondingly.

As mentioned above, the control apparatus of an electronic system of this invention controls the electronic system according to various kinds of predetermined conditions that the user can operate the electronic system according to the actual embodiments. Comparing to the electronic system in the prior art, it improves the inconvenient caused by the electronic system in order to reach the power saving topic. The control apparatus of an electronic system of this invention provides a control apparatus and the method therefore that both having the power saving function and the convenient in usage which are advantages of the control apparatus of an electronic system and the method therefore of this invention.

Those skilled in the art will readily observe that numerous modifications and alterations of the apparatus and the method may be made while retaining the teachings of the invention. Accordingly, the above disclosure should be construed as limited only by the metes and bounds of the appended claims.

What is claimed is:

1. A control apparatus of an electronic system, comprising:
a setting module for setting a first predetermined condition and a second predetermined condition;
an input module for generating at least one input information;
a judging module coupled to the setting module and the input module for judging whether a electronic system match the first predetermined condition and generating a judging signal according to the judging result;
a comparing module coupled to the setting module and the input module for comparing the at least one input information with the second predetermined condition and generating a comparing signal according to the comparing result;
a control module coupled to the judging module and the comparing module for generating a first control signal or the second control signal according to the judging signal and the comparing signal respectively; and
a power module coupled to the control module for providing a first power or a second power to the electronic system according to the first control signal or the second control signal respectively;
wherein when the at least one input information matches the second predetermined condition, the power module provides the second power mode to the electronic system corresponding to the second condition, if not, the power module provides the first power mode to the electronic system corresponding to the first predetermined condition.

2. The control apparatus of an electronic system of claim 1, wherein the control apparatus further comprises a display module coupled to the power module for displaying frames.

3. The control apparatus of an electronic system of claim 2, wherein the second power mode provides the electronic system power that enables the display module for displaying the frames and the first power mode provides power for disabling the display module.

4. The control apparatus of an electronic system of claim 1, the judging module further comprising a counting unit, wherein the first predetermined condition is that when the input module generates the at least one input information, the counting unit starts counts a predetermined time period to generate the judging signal.

5. The control apparatus of an electronic system of claim 4, wherein the insulating module includes at least one hole for connecting the first operating module, the second operating module and the third operating module to the electronic system.

6. The control apparatus of an electronic system of claim 1, wherein the second predetermined condition is an operation gesture.

7. The control apparatus of an electronic system of claim 1, wherein the setting module generates the first predetermined condition and the second predetermined condition according to the operations executed via the input module by the user.

8. The control apparatus of an electronic system of claim 7, wherein the input module is a touch panel.

9. The control apparatus of an electronic system of claim 1, wherein the electronic system is a computer, a tablet PC, a notebook or a smart phone.

10. A control method of an electronic system, comprising following steps:
(a) setting a first predetermined condition and a second predetermined condition;
(b) generating at least one input information via an input module;
(c) judging whether an electronic system matching the first predetermined condition and generating a judging signal according to the judging result;
(d) comparing the at least one input information with the second predetermined condition and generating a comparing signal according to the comparing result;
(e) generating a first control signal or the second control signal according to the judging signal and the comparing signal respectively; and
(f) providing a first power or a second power to the electronic system according to the first control signal or the second control signal respectively;
wherein when the at least one input information matches the second predetermined condition, the step (f) provides the second power mode to the electronic system corresponding to the second condition, if not, the step (f) provides the first power mode to the electronic system corresponding to the first predetermined condition.

11. The control method of an electronic system of claim 10, wherein the method further comprises displaying frames via a display module.

12. The control method of an electronic system of claim 11, wherein the second power mode provides the display module power for displaying frames and the first power mode provides power for disabling the display module.

13. The control method of an electronic system of claim 10, wherein the first predetermined condition is that when the step (b) does not generating the at least one input information, the step (c) starts counting a predetermined time period to generate the judging signal.

14. The control method of an electronic system of claim 13, wherein if the step (c) counting the predetermined time period, the step (e) generates the first control signal according to the judging signal.

15. The control method of an electronic system of claim 13, wherein when the step (a) generates the at least one input information, the step (c) restarts counting.

16. The control method of an electronic system of claim 10, wherein the second predetermined condition is an operation gesture.

17. The control method of an electronic system of claim 10, wherein the first predetermined condition and the second predetermined condition of the step are setting according to the operations executed via the input module by the user in prior.
